(19) United States
(12) Patent Application Publication
(10) Pub. No.: US 2023/0065704 A1
(43) Pub. Date: Mar. 2, 2023

(54) TEACHER DATA GENERATION APPARATUS AND TEACHER DATA GENERATION METHOD

(71) Applicant: Mitsubishi Electric Corporation, Tokyo (JP)

(72) Inventor: Takayuki ITSUI, Tokyo (JP)

(73) Assignee: Mitsubishi Electric Corporation, Tokyo (JP)

(21) Appl. No.: 17/795,105

(22) PCT Filed: Apr. 9, 2020
(86) PCT No.: PCT/JP2020/016018

§ 371 Date: Jul. 25, 2022

(51) Int. Cl. B60W 60/00; B60W 40/06; B60W 50/00; G06V 20/56; G06N 20/00

(52) U.S. Cl. CPC B60W 60/001; B60W 40/06; B60W 50/0098; G06V 20/588; G06N 20/00; B60W 2050/0028; B60W 2050/0083; B60W 2420/42

(57) ABSTRACT

Included are: a simulation data acquiring unit to acquire simulation sensor data and acquire simulation traveling data; a feature amount calculating unit to calculate a feature amount from the simulation sensor data; a hyperparameter evaluation unit to evaluate whether or not a hyperparameter is a determined hyperparameter by comparing the simulation traveling data with ideal traveling data; a hyperparameter determination control unit to reset the hyperparameter until the hyperparameter evaluation unit evaluates that the hyperparameter is the determined hyperparameter, and repeatedly operate a mobile object simulator; and a teacher data generating unit to generate teacher data in which the hyperparameter evaluated as the determined hyperparameter by the hyperparameter evaluation unit and the feature amount calculated by the feature amount calculating unit are paired.

### TECHNICAL FIELD

The present disclosure relates to a teacher data generation apparatus that generates teacher data and a teacher data generation method.

### BACKGROUND ART

Conventionally, in the field of autonomous driving of a mobile object, a technique of learning a control amount of a vehicle for each traveling state is known (for example, Patent Literature 1).

### CITATION LIST

### Patent Literature

Patent Literature 1: JP 2019-10967 A

### SUMMARY OF INVENTION

### Technical Problem

In a mobile object control technology such as model predictive control or PID control, there is a problem that it is necessary to manually set a hyperparameter corresponding to a traveling state in order to obtain a control amount corresponding to the traveling state. The hyperparameter is a weight of an evaluation function or the like.

The present disclosure has been made to solve the above problems, and an object of the present disclosure is to provide a teacher data generation apparatus that enables setting of a hyperparameter corresponding to a traveling state without manual operation, the hyperparameter being used in a mobile object control technology.

### Solution to Problem

A teacher data generation apparatus according to the present disclosure includes: a simulation data acquiring unit to acquire simulation sensor data indicating a surrounding environment of a mobile object, the simulation sensor data being reproduced in a mobile object simulator that acquires a control amount of the mobile object using a hyperparameter, and acquire simulation traveling data indicating a track on which the mobile object has traveled in the mobile object simulator; a feature amount calculating unit to calculate a feature amount from the simulation sensor data acquired by the simulation data acquiring unit; a hyperparameter evaluation unit to evaluate whether or not the hyperparameter is a determined hyperparameter by comparing the simulation traveling data acquired by the simulation data acquiring unit with ideal traveling data; a hyperparameter determination control unit to, when the hyperparameter evaluation unit evaluates that the hyperparameter is not the determined hyperparameter, reset the hyperparameter until the hyperparameter evaluation unit evaluates that the hyperparameter is the determined hyperparameter, and repeatedly operate the mobile object simulator to acquire a control amount of the mobile object using the reset hyperparameter; and a teacher data generating unit to generate teacher data in which the hyperparameter evaluated as the determined hyperparameter by the hyperparameter evaluation unit and the feature amount calculated by the feature amount calculating unit are paired.

### Advantageous Effects of Invention

According to the teacher data generation apparatus of the present disclosure, it is possible to automatically generate the teacher data for learning by a model that is used in a mobile object control technology and outputs a hyperparameter corresponding to a traveling state. Then, on the basis of the model learned on the basis of the teacher data generated in the teacher data generation apparatus according to the present disclosure, it is possible to acquire a hyperparameter corresponding to the traveling state. Therefore, in the mobile object control technology, the hyperparameter corresponding to the traveling state can be set without manual operation.

### BRIEF DESCRIPTION OF DRAWINGS

FIG. 1 is a diagram illustrating a configuration example of an autonomous driving vehicle equipped with an autonomous driving control device according to a first embodiment.

FIG. 2 is a flowchart for explaining an operation of a teacher data generation apparatus according to the first embodiment.

FIGS. 3A and 3B are diagrams illustrating an example of a hardware configuration of the teacher data generation apparatus according to the first embodiment.

### DESCRIPTION OF EMBODIMENTS

Hereinafter, an embodiment of the present invention will be described in detail with reference to the drawings.

### First Embodiment

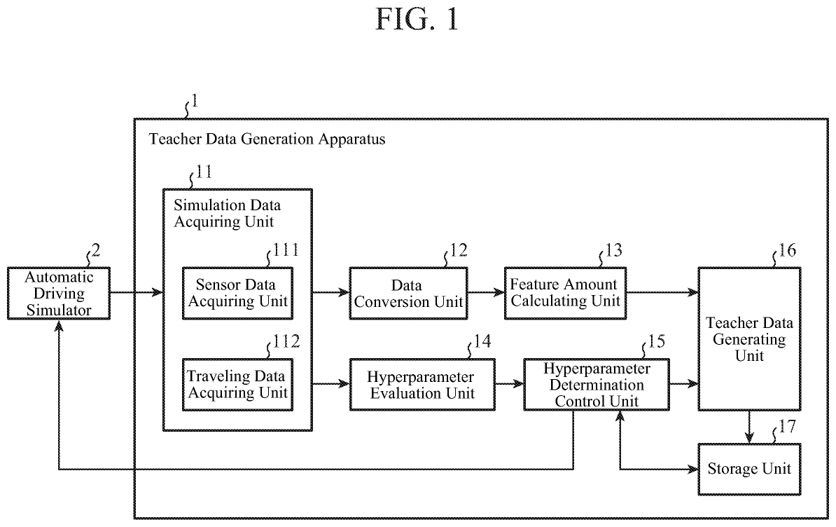

FIG. 1 is a diagram illustrating a configuration example of a teacher data generation apparatus 1 according to a first embodiment.

In the first embodiment, a mobile object is assumed to be a vehicle. Further, the teacher data generation apparatus 1 according to the first embodiment is assumed to be provided in a server. Note that this is merely an example, and for example, a personal computer (PC) in general can be configured to include the teacher data generation apparatus 1. The teacher data generation apparatus 1 according to the first embodiment is connected to an automatic driving simulator 2. The automatic driving simulator 2 is a so-called automatic driving simulator using a general simulation technology. The automatic driving simulator 2 calculates the control amount of the mobile object using a known mobile object control technology such as model predictive control or PID control. In the first embodiment, the control amount of the mobile object is a control amount for performing driving control of the mobile object. In the first embodiment, it is assumed that the automatic driving simulator 2 calculates the control amount of the mobile object using a known technique of model predictive control. At that time, the automatic driving simulator 2 uses a hyperparameter.

In the model predictive control, a model for predicting future behavior is generated in advance on the basis of vehicle dynamics, and what kind of input is most suitable to be given is calculated on the basis of the model on the basis of an evaluation function and a constraint condition. The hyperparameter is a weight of an evaluation function in the model predictive control or a threshold in a constraint condition. The automatic driving simulator 2 calculates an optimum control amount of the mobile object on the basis of the model predictive control. In the PID control, the hyperparameter is a proportional gain, an integral gain, and a differential gain.

The teacher data generation apparatus 1 according to the first embodiment generates teacher data on the basis of simulation data acquired from the automatic driving simulator 2. Details of the simulation data and the teacher data will be described later. The teacher data generated by the teacher data generation apparatus 1 is used, for example, when an in-vehicle device (not illustrated) mounted on a mobile object generates a learned model in machine learning (hereinafter, referred to as a “machine learning model”). The machine learning model is a model that receives, as an input, a feature amount corresponding to a traveling state calculated from sensor data (hereinafter referred to as “actual sensor data”) indicating a surrounding environment of a mobile object when the mobile object actually travels, and outputs a hyperparameter. In the first embodiment, the traveling state means various shapes of a road on which the mobile object travels, such as a straight road, a curve, an upward slope, a downward slope, or an intersection, or a traveling speed when the mobile object travels on roads of various shapes.

The hyperparameter obtained on the basis of the machine learning model is used, for example, for calculating a control amount of a mobile object when the mobile object actually travels in an in-vehicle device. The in-vehicle device calculates the control amount of the mobile object using a mobile object control technology such as model predictive control or PID control.

In the first embodiment, a mobile object control technology for calculating a control amount of a mobile object is model predictive control.

The control amount calculated by the in-vehicle device is used for autonomous driving control in a mobile object, in other words, a vehicle. In the first embodiment, it is assumed that the vehicle has an autonomous driving function. Even when the vehicle has an autonomous driving function, the driver can drive the vehicle by himself or herself without executing the autonomous driving function.

As illustrated in FIG. 1, the teacher data generation apparatus 1 includes a simulation data acquiring unit 11, a data conversion unit 12, a feature amount calculating unit 13, a hyperparameter evaluation unit 14, a hyperparameter determination control unit 15, a teacher data generating unit 16, and a storage unit 17.

The simulation data acquiring unit 11 includes a sensor data acquiring unit 111 and a traveling data acquiring unit 112.

The simulation data acquiring unit 11 acquires simulation data from the automatic driving simulator 2.

More specifically, the sensor data acquiring unit 111 of the simulation data acquiring unit 11 acquires simulation data (hereinafter, referred to as “simulation sensor data”) indicating the surrounding environment of the mobile object reproduced in the automatic driving simulator 2. The simulation sensor data is, for example, an image. In the first embodiment, the description will be given below assuming that the simulation sensor data is an image (hereinafter, referred to as a “simulation image”) reproduced in the automatic driving simulator 2. Note that the simulation sensor data may be numerical data such as LiDAR data.

The automatic driving simulator 2 generates a designated specific traveling state (hereinafter, referred to as “specific traveling state”), and travels in accordance with a control amount obtained on the basis of the model predictive control in the generated specific traveling state. At that time, the automatic driving simulator 2 uses a hyperparameter. In the automatic driving simulator 2, the hyperparameter used when calculating a control amount is given by the hyperparameter determination control unit 15. When the automatic driving simulator 2 operates for the first time after the power is turned on, the hyperparameter determination control unit 15 gives a preset initial value of the hyperparameter to the automatic driving simulator 2. Details of the hyperparameter determination control unit 15 will be described later.

The specific traveling state is designated by a user in advance. The specific traveling state is not limited to one type of traveling state. For the specific traveling state, a plurality of different types of traveling states can be designated in advance. For example, the automatic driving simulator 2 travels in the specific traveling state for each of the specific traveling states.

The sensor data acquiring unit 111 acquires, from the automatic driving simulator 2, a simulation image reproduced by the automatic driving simulator 2 while the automatic driving simulator 2 travels in the specific traveling state in units of the specific traveling state. The sensor data acquiring unit 111 may acquire the simulation image reproduced by the automatic driving simulator 2 within the data acquisition time from the automatic driving simulator 2 in units of preset time (hereinafter, referred to as “data acquisition time”). As the data acquisition time, a short time is set in advance to such an extent as to be obtained when traveling in a traveling state in which all frames of the simulation image reproduced within the data acquisition time are similar, in other words, in the same type of specific traveling state.

The sensor data acquiring unit 111 acquires the simulation image in units of frames. For example, the sensor data acquiring unit 111 acquires, from the automatic driving simulator 2, one or more frames of simulation images reproduced by the automatic driving simulator 2 within the data acquisition time.

The sensor data acquiring unit 111 outputs the acquired simulation image to the data conversion unit 12.

The traveling data acquiring unit 112 of the simulation data acquiring unit 11 acquires simulation data (hereinafter, referred to as “simulation traveling data”) indicating a track on which the mobile object has traveled in the automatic driving simulator 2.

Specifically, for example, the traveling data acquiring unit 112 acquires, from the automatic driving simulator 2, simulation traveling data indicating a track on which the mobile object has traveled in a certain specific traveling state in the automatic driving simulator 2. In addition, for example, the traveling data acquiring unit 112 acquires, from the automatic driving simulator 2, data indicating a track on which the mobile object has traveled in the data acquisition time.

The traveling data acquiring unit 112 outputs the acquired simulation traveling data to the hyperparameter evaluation unit 14.

The data conversion unit 12 performs data conversion on data elements included in the simulation sensor data acquired by the sensor data acquiring unit 111 of the simulation data acquiring unit 11. The data conversion unit 12 performs data conversion in accordance with a preset conversion rule. For example, the data conversion unit 12 performs the data conversion using a known semantic segmentation technology. As a specific example, for example, the data conversion unit 12 performs data conversion for color-coding pixels of the simulator image, such as blue for a pixel indicating a car, pink for a pixel indicating a road, or green for a pixel indicating a street tree, among pixels included in the simulation image. Furthermore, in a case where the simulation sensor data is numerical data, the data conversion unit 12 performs, for example, data conversion to add noise to the numerical data in such a way as to bring the numerical data closer to sensor data (hereinafter, referred to as “actual sensor data”) indicating a surrounding environment of the mobile object, the sensor data being acquired when the mobile object actually travels.

The simulation image reproduced by the automatic driving simulator 2 is, for example, a computer graphics (CG) image. On the other hand, the actual sensor data is, for example, a captured image (hereinafter, referred to as a “camera image”) captured by a camera mounted on the mobile object. Note that the feature amount calculated from the camera image is used to calculate the control amount of the mobile object when the mobile object actually travels.

Here, there is a possibility that the feature amounts to be calculated as the same feature amount are not calculated as the same feature amount between a case where the feature amount is calculated from the CG image and a case where the feature amount is calculated from the camera image.

The teacher data generation apparatus 1 includes the feature amount calculated from the CG image in the teacher data to be generated. Note that the feature amount calculating unit 13 calculates the feature amount from the simulation image. The teacher data is generated by the teacher data generating unit 16. Details of the feature amount calculating unit 13 and the teacher data generating unit 16 will be described later. As described above, the teacher data generated by the teacher data generation apparatus 1 is used to generate the machine learning model for calculating the hyperparameter used to calculate the control amount of the mobile object when the mobile object actually travels.

Then, when the control amount of the mobile object is calculated from the feature amount calculated from the camera image, there is a possibility that an appropriate control amount is not calculated if a hyper parameter based on the machine learning model generated on the basis of the teacher data including the feature amount calculated from the simulation image is used.

Therefore, the data conversion unit 12 performs data conversion on the simulation image to absorb the difference between the case of being calculated from the simulation image and the case of being calculated from the camera image, with regard with the feature amount to be calculated as the same feature amount. As a result, the teacher data generation apparatus 1 can reduce the possibility that the control amount is not appropriately calculated since the hyperparameter used when calculating the control amount of the mobile object is calculated on the basis of the feature amount different from the feature amount from which the control amount of the mobile object is calculated.

Note that data conversion similar to the data conversion performed on the simulation image by the data conversion unit 12 also needs to be performed on the camera image that is the actual sensor data before the feature amount is calculated.

The data conversion unit 12 performs data conversion on each frame of the simulation image.

The data conversion unit 12 outputs the simulation image after the data conversion (hereinafter, referred to as a “simulation image after conversion”) to the feature amount calculating unit 13.

The feature amount calculating unit 13 calculates a feature amount corresponding to the traveling state of the mobile object from the simulation image after conversion converted by the data conversion unit 12.

The feature amount calculating unit 13 calculates a feature amount using a known technique such as image processing or machine learning.

Note that the feature amount calculating unit 13 calculates a feature amount from each frame of the simulation image after conversion.

The feature amount calculating unit 13 outputs the calculated feature amount to the teacher data generating unit 16. The feature amount calculating unit 13 outputs the calculated feature amount in association with the frame of the simulation image after conversion, for example.

The hyperparameter evaluation unit 14 compares the simulation traveling data acquired by the traveling data acquiring unit 112 of the simulation data acquiring unit 11 with traveling data stored in advance (hereinafter, referred to as “ideal traveling data”) to evaluate whether or not the hyperparameter is a determined hyperparameter. Note that the hyperparameter evaluated by the hyperparameter evaluation unit 14 is a hyperparameter used by the automatic driving simulator 2 when calculating the control amount. In the first embodiment, the “determined hyperparameter” refers to a hyperparameter optimal as a hyperparameter used when the automatic driving simulator 2 calculates a control amount from a certain feature amount.

The hyperparameter evaluation unit 14 may acquire information regarding the hyperparameter from, for example, the automatic driving simulator 2 via the traveling data acquiring unit 112, or may acquire the hyperparameter by referring to the storage unit 17. As described above, the hyperparameter used when the automatic driving simulator 2 calculates the control amount is given by the hyperparameter determination control unit 15. The hyperparameter determination control unit 15 provides a hyperparameter to the automatic driving simulator 2 and stores the hyperparameter in the storage unit 17. Details of the hyperparameter determination control unit 15 will be described later.

The ideal traveling data is, for example, data indicating a track on which a mobile object has traveled when an excellent driver has driven the mobile object in a certain traveling state in advance. Here, the certain traveling state is a traveling state similar to the specific traveling state traveled by the automatic driving simulator 2. For example, the automatic driving simulator 2 outputs, to the traveling data acquiring unit 112, information that can specify the specific traveling state in which the mobile object has traveled in the automatic driving simulator 2 in association with the simulation traveling data. The hyperparameter evaluation unit 14 may acquire, via the traveling data acquiring unit 112, information that can specify the specific traveling state in which the automatic driving simulator 2 has traveled.

For example, the hyperparameter evaluation unit 14 compares a point on the track indicated by the traveling data with a point on the track indicated by the ideal traveling data for each lapse of a preset time such as 1 minute from the start of traveling, and calculates a cumulative value of the differences resulting from the comparison as an evaluation value. When the calculated evaluation value is equal to or less than a preset threshold (hereinafter, referred to as an “evaluation threshold”), the hyperparameter evaluation unit 14 evaluates that the hyperparameter is a determined hyperparameter. In other words, the hyperparameter evaluation unit 14 determines the hyperparameter as the determined hyperparameter. When the calculated evaluation value is larger than the evaluation threshold, the hyperparameter evaluation unit 14 evaluates that the hyperparameter is not the determined hyperparameter.

When the hyperparameter evaluation unit 14 evaluates that the hyperparameter is the determined hyperparameter, it can be said that the traveling result in accordance with the control amount calculated using the determined hyperparameter is close to the ideal traveling. When the hyperparameter evaluation unit 14 evaluates that the hyperparameter is not the determined hyperparameter, it can be said that the traveling result in accordance with the control amount calculated using the hyperparameter determined not to be the determined hyperparameter is not close to the ideal traveling.

The hyperparameter evaluation unit 14 outputs the evaluation result of the hyperparameter, in other words, information indicating whether or not the hyperparameter is a determined hyperparameter, to the hyperparameter determination control unit 15. At this time, the hyperparameter evaluation unit 14 also outputs information regarding the hyperparameter to the hyperparameter determination control unit 15.

The hyperparameter determination control unit 15 determines whether or not it is necessary to reset the hyperparameter on the basis of the evaluation result of the hyperparameter by the hyperparameter evaluation unit 14.

When the hyperparameter evaluation unit 14 evaluates that the hyperparameter is a determined hyperparameter, the hyperparameter determination control unit 15 determines that it is not necessary to reset the hyperparameter. Specifically, when information indicating that the hyperparameter is the determined hyperparameter is output from the hyperparameter evaluation unit 14, the hyperparameter determination control unit 15 determines that it is not necessary to reset the hyperparameter.

The hyperparameter determination control unit 15 outputs the hyperparameter stored in the storage unit 17 to the teacher data generating unit 16 as a determined hyperparameter.

When the hyperparameter evaluation unit 14 does not evaluate that the hyperparameter is a determined hyperparameter, the hyperparameter determination control unit 15 determines that it is necessary to reset the hyperparameter. Specifically, when information indicating that the hyperparameter is not the determined hyperparameter is output from the hyperparameter evaluation unit 14, the hyperparameter determination control unit 15 determines that it is necessary to reset the hyperparameter.

Then, the hyperparameter determination control unit 15 resets the hyperparameter. For example, the hyperparameter determination control unit 15 may reset the hyperparameter using a known technique such as Bayesian optimization on the basis of the hyperparameter and the evaluation value calculated by the hyperparameter evaluation unit 14. The hyperparameter determination control unit 15 updates the hyperparameter stored in the storage unit 17 to the hyperparameter after resetting. Furthermore, the hyperparameter determination control unit 15 transmits the hyperparameter after resetting to the automatic driving simulator 2, and causes the automatic driving simulator 2 to operate in such a way as to calculate the control amount using the hyperparameter after resetting. When the hyperparameter after resetting is transmitted, the automatic driving simulator 2 travels again in the specific traveling state using the hyperparameter after resetting, and outputs the simulation data to the simulation data acquiring unit 11.

The hyperparameter determination control unit 15 resets the hyperparameter until the hyperparameter evaluation unit 14 evaluates that the hyperparameter is a determined hyperparameter, and repeatedly operates the automatic driving simulator 2 in such a way as to calculate the control amount using the hyperparameter after resetting.

The teacher data generating unit 16 generates teacher data in which the determined hyperparameter output from the hyperparameter determination control unit 15, in other words, the hyperparameter evaluated as the determined hyperparameter by the hyperparameter evaluation unit 14 and the feature amount calculated by the feature amount calculating unit 13 are paired.

Note that the teacher data generating unit 16 pairs the latest feature amount, in other words, the last output feature amount among the feature amounts output from the feature amount calculating unit 13 until the determined hyperparameter is output from the hyperparameter determination control unit 15, with the determined hyperparameter.

One or more feature amounts each calculated from the simulation images of one or more frames can be output from the feature amount calculating unit 13. The teacher data generating unit 16 pairs each of one or more feature amounts output from the feature amount calculating unit 13 with the determined hyperparameter.

The teacher data generating unit 16 stores the generated teacher data in the storage unit 17.

The storage unit 17 stores the hyperparameter set by the hyperparameter determination control unit 15. In addition, the storage unit 17 stores the teacher data generated by the teacher data generating unit 16.

In the first embodiment, as illustrated in FIG. 1, the storage unit 17 is provided in the teacher data generation apparatus 1, but this is merely an example. The storage unit 17 may be provided in a place that can be referred to by the teacher data generation apparatus 1 outside the teacher data generation apparatus 1.

An operation of the teacher data generation apparatus 1 according to the first embodiment will be described.

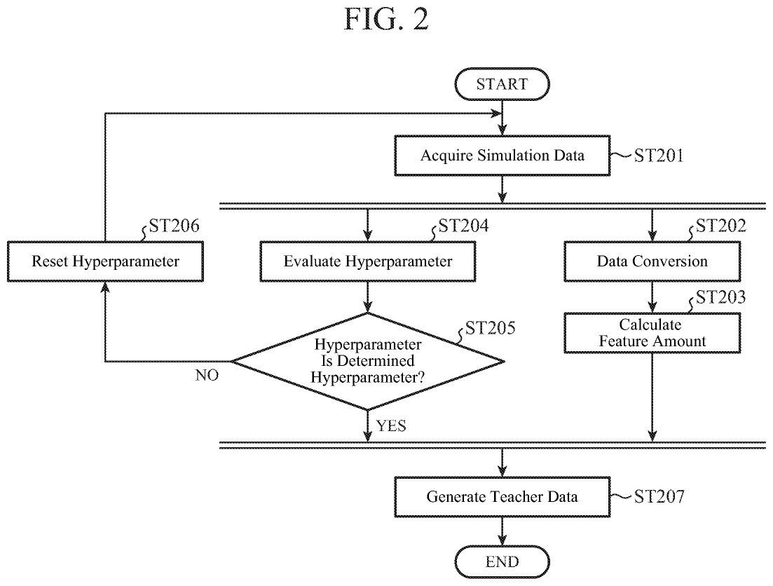

FIG. 2 is a flowchart for explaining the operation of the teacher data generation apparatus 1 according to the first embodiment.

The simulation data acquiring unit 11 acquires simulation data from the automatic driving simulator 2 (step ST201).

More specifically, the sensor data acquiring unit 111 of the simulation data acquiring unit 11 acquires the simulation image reproduced in the automatic driving simulator 2. The sensor data acquiring unit 111 outputs the acquired simulation image to the data conversion unit 12.

The traveling data acquiring unit 112 of the simulation data acquiring unit 11 acquires simulation traveling data. The traveling data acquiring unit 112 outputs the acquired simulation traveling data to the hyperparameter evaluation unit 14.

The data conversion unit 12 performs data conversion for each group of data elements forming a characteristic category for the data elements included in the simulation image acquired by the sensor data acquiring unit 111 of the simulation data acquiring unit 11 in step ST201 (step ST202).

The data conversion unit 12 outputs the simulation image after conversion to the feature amount calculating unit 13.

The feature amount calculating unit 13 calculates a feature amount corresponding to the traveling state of the mobile object from the simulation image after conversion converted by the data conversion unit 12 in step ST202 (step ST203).

The feature amount calculating unit 13 outputs the calculated feature amount to the teacher data generating unit 16.

The hyperparameter evaluation unit 14 compares the simulation traveling data acquired by the traveling data acquiring unit 112 of the simulation data acquiring unit 11 in step ST201 with the ideal traveling data to evaluate whether or not the hyperparameter is a determined hyperparameter (step ST204).

The hyperparameter evaluation unit 14 outputs the evaluation result of the hyperparameter, in other words, information indicating whether or not the hyperparameter is a determined hyperparameter, to the hyperparameter determination control unit 15. At this time, the hyperparameter evaluation unit 14 also outputs information regarding the hyperparameter to the hyperparameter determination control unit 15.

The hyperparameter determination control unit 15 determines whether or not it is necessary to reset the hyperparameter on the basis of the evaluation result of the hyperparameter by the hyperparameter evaluation unit 14 in step ST204. Specifically, the hyperparameter determination control unit 15 determines whether or not information indicating that the hyperparameter is a determined hyperparameter has been output from the hyperparameter evaluation unit 14 (step ST205).

If it is determined in step ST205 that information indicating that the hyperparameter is not a determined hyperparameter has been output (“NO” in step ST205), the hyperparameter determination control unit 15 determines that it is necessary to reset the hyperparameter. Then, the hyperparameter determination control unit 15 resets the hyperparameter (step ST206). The hyperparameter determination control unit 15 updates the hyperparameter stored in the storage unit 17 to the hyperparameter after resetting. Furthermore, the hyperparameter determination control unit 15 transmits the hyperparameter after resetting to the automatic driving simulator 2, and causes the automatic driving simulator 2 to operate in such a way as to calculate the control amount using the hyperparameter after resetting.

Then, the operation of the teacher data generation apparatus 1 returns to step ST201.

When the hyperparameter after resetting is transmitted, the automatic driving simulator 2 travels again in the specific traveling state using the hyperparameter after resetting, and outputs the simulation data to the simulation data acquiring unit 11.

If it is determined in step ST205 that information indicating that the hyperparameter is a determined hyperparameter has been output (“YES” in step ST205), the hyperparameter determination control unit 15 outputs the hyperparameter stored in the storage unit 17 to the teacher data generating unit 16 as a determined hyperparameter.

The teacher data generating unit 16 generates teacher data in which the determined hyperparameter output from the hyperparameter determination control unit 15 in step ST205 and the feature amount calculated by the feature amount calculating unit 13 in step ST203 are paired (step ST207).

The teacher data generating unit 16 stores the generated teacher data in the storage unit 17.

When the operation of step ST207 is completed, the teacher data generation apparatus 1 ends the operation. The teacher data generation apparatus 1 may cause the automatic driving simulator 2 to operate in such a way as to travel in another specific traveling state, and again perform the operation described with reference to FIG. 2.

As described above, the teacher data generation apparatus 1 evaluates the hyperparameter by comparing the simulation traveling data acquired from the automatic driving simulator 2 that acquires the control amount of the mobile object using the hyperparameter with the ideal traveling data. The teacher data generation apparatus 1 repeats resetting of a hyperparameter and operation control of the automatic driving simulator 2 using the reset hyperparameter until the hyperparameter becomes a determined hyperparameter that can be evaluated as an optimal hyperparameter. Then, when determining the determined hyperparameter, the teacher data generation apparatus 1 generates teacher data in which the determined hyperparameter and a feature amount calculated from the simulation sensor data and corresponding to the traveling state are paired. Therefore, the teacher data generation apparatus 1 can automatically generate the teacher data for learning by the machine learning model that outputs the hyperparameter corresponding to the traveling state. Then, on the basis of the machine learning model learned on the basis of the teacher data generated in the teacher data generation apparatus 1, it is possible to acquire the hyperparameter corresponding to the traveling state. Therefore, in the mobile object control technology, the hyperparameter corresponding to the traveling state can be set without manual operation.

In the first embodiment described above, the teacher data generation apparatus 1 includes the data conversion unit 12, but the teacher data generation apparatus 1 does not necessarily include the data conversion unit 12. The feature amount calculating unit 13 may calculate the feature amount from the simulation sensor data acquired by the sensor data acquiring unit 111.

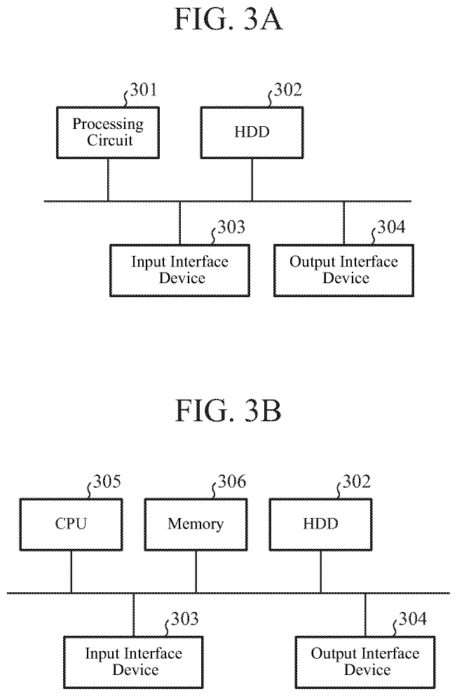

FIGS. 3A and 3B are diagrams illustrating an example of a hardware configuration of the teacher data generation apparatus 1 according to the first embodiment.

In the first embodiment, the functions of the simulation data acquiring unit 11, the data conversion unit 12, the feature amount calculating unit 13, the hyperparameter evaluation unit 14, the hyperparameter determination control unit 15, and the teacher data generating unit 16 are implemented by a processing circuit 301. That is, the teacher data generation apparatus 1 includes the processing circuit 301 for performing control to generate teacher data when the machine learning model learns.

The processing circuit 301 may be dedicated hardware as illustrated in FIG. 3A, or may be a central processing unit (CPU) 305 that executes a program stored in a memory 306 as illustrated in FIG. 3B.

In a case where the processing circuit 301 is dedicated hardware, the processing circuit 301 corresponds to, for example, a single circuit, a composite circuit, a programmed processor, a parallel programmed processor, an application specific integrated circuit (ASIC), a field-programmable gate array (FPGA), or a combination thereof.

When the processing circuit 301 is the CPU 305, the functions of the simulation data acquiring unit 11, the data conversion unit 12, the feature amount calculating unit 13, the hyperparameter evaluation unit 14, the hyperparameter determination control unit 15, and the teacher data generating unit 16 are implemented by software, firmware, or a combination of software and firmware. That is, the simulation data acquiring unit 11, the data conversion unit 12, the feature amount calculating unit 13, the hyperparameter evaluation unit 14, the hyperparameter determination control unit 15, and the teacher data generating unit 16 are implemented by a processing circuit such as a CPU 305 and a system large-scale integration (LSI) that execute a program stored in a hard disk drive (HDD) 302, the memory 306, or the like. It can also be said that the program stored in the HDD 302, the memory 306, or the like causes a computer to execute a procedure or a method performed by the simulation data acquiring unit 11, the data conversion unit 12, the feature amount calculating unit 13, the hyperparameter evaluation unit 14, the hyperparameter determination control unit 15, and the teacher data generating unit 16. Here, the memory 306 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), or a magnetic disk, a flexible disk, an optical disk, a compact disk, a mini disk, a digital versatile disc (DVD), or the like.

Note that the functions of the simulation data acquiring unit 11, the data conversion unit 12, the feature amount calculating unit 13, the hyperparameter evaluation unit 14, the hyperparameter determination control unit 15, and the teacher data generating unit 16 may be partially implemented by dedicated hardware and partially implemented by software or firmware. For example, the functions of the simulation data acquiring unit 11 can be implemented by the processing circuit 301 as dedicated hardware, and the functions of the data conversion unit 12, the feature amount calculating unit 13, the hyperparameter evaluation unit 14, the hyperparameter determination control unit 15, and the teacher data generating unit 16 can be implemented by the processing circuit 301 reading and executing programs stored in the memory 306.

Furthermore, the storage unit 17 uses the memory 306. Note that this is an example, and the storage unit 17 may be configured by the HDD 302, a solid state drive (SSD), a DVD, or the like.

In addition, the teacher data generation apparatus 1 includes an input interface device 303 and an output interface device 304 that perform wired communication or wireless communication with a device such as the automatic driving simulator 2.

In the first embodiment described above, the mobile object is a vehicle, but this is merely an example. The teacher data generation apparatus 1 according to the first embodiment can be used, for example, as an apparatus for generating teacher data in learning a machine learning model that outputs a hyperparameter in order to set a hyperparameter for calculating a control amount of a mobile object when the mobile object actually travels, in various mobile objects capable of performing control simulation using a simulator technology of a mobile object simulator without manual operation.

As described above, according to the first embodiment, the teacher data generation apparatus 1 includes the simulation data acquiring unit 11 to acquire simulation sensor data indicating the surrounding environment of the mobile object, the simulation sensor data being reproduced in a mobile object simulator (for example, the automatic driving simulator 2) that acquires a control amount of the mobile object using a hyperparameter, and acquire simulation traveling data indicating the track on which the mobile object has traveled in the mobile object simulator, the feature amount calculating unit 13 to calculate the feature amount from the simulation sensor data acquired by the simulation data acquiring unit 11, the hyperparameter evaluation unit 14 to evaluate whether or not the hyperparameter is a determined hyperparameter by comparing the simulation traveling data acquired by the simulation data acquiring unit 11 with the ideal traveling data, the hyperparameter determination control unit 15 to, when the hyperparameter evaluation unit 14 evaluates that the hyperparameter is not the determined hyperparameter, reset the hyperparameter until the hyperparameter evaluation unit 14 evaluates that the hyperparameter is the determined hyperparameter, and repeatedly operate the mobile object simulator to acquire a control amount of the mobile object using the reset hyperparameter, and the teacher data generating unit 16 to generate teacher data in which the hyperparameter evaluated as the determined hyperparameter by the hyperparameter evaluation unit 14 and the feature amount calculated by the feature amount calculating unit 13 are paired. Therefore, the teacher data generation apparatus 1 can automatically generate the teacher data for learning by the machine learning model that is used in the mobile object control technology and outputs the hyperparameter corresponding to the traveling state. Then, on the basis of the machine learning model learned on the basis of the teacher data generated in the teacher data generation apparatus 1, it is possible to acquire the hyperparameter corresponding to the traveling state. Therefore, in the mobile object control technology, the hyperparameter corresponding to the traveling state can be set without manual operation.

Note that, in the present disclosure, it is possible to modify any component of the embodiment or omit any component of the embodiment within the scope of the present disclosure.

### INDUSTRIAL APPLICABILITY

Since the teacher data generation apparatus according to the present disclosure is configured to be able to automatically generate the teacher data for learning by the model that is used in the mobile object control technology and outputs the hyperparameter corresponding to the traveling state, the hyperparameter corresponding to the traveling state can be acquired on the basis of the model learned on the basis of the teacher data generated in the teacher data generation apparatus, and the hyperparameter corresponding to the traveling state can be set in the mobile object control technology without manual operation.

### REFERENCE SIGNS LIST

1: teacher data generation apparatus, 11: simulation data acquiring unit, 111: sensor data acquiring unit, 112: traveling data acquiring unit, 12: data conversion unit, 13: control amount calculating unit, 14: hyperparameter evaluation unit, 15: hyperparameter determination control unit, 16: teacher data generating unit, 17: storage unit, 2: automatic driving simulator, 301: processing circuit, 302: HDD, 303: input interface device, 304: output interface device, 305: CPU, 306: memory

1. A teacher data generation apparatus, comprising:
processing circuitry configured to
acquire simulation sensor data indicating a surrounding environment of a mobile object, the simulation sensor data being reproduced in a mobile object simulator that acquires a control amount of the mobile object using a hyperparameter, and acquire simulation traveling data indicating a track on which the mobile object has traveled in the mobile object simulator;
calculate a feature amount from the acquired simulation sensor data;
evaluate whether or not the hyperparameter is a determined hyperparameter by comparing the acquired simulation traveling data with ideal traveling data;
reset the hyperparameter when processing circuitry evaluates that the hyperparameter is not the determined hyperparameter, and repeatedly reset the hyperparameter until the processing circuitry evaluates that the hyperparameter is the determined hyperparameter;
repeatedly operate the mobile object simulator to acquire a control amount of the mobile object using the reset hyperparameter; and
generate teacher data in which the hyperparameter evaluated as the determined hyperparameter and the calculated feature amount are paired.

2. The teacher data generation apparatus according to claim 1,
wherein
the processing circuitry calculates an evaluation value based on a difference between the simulation traveling data and the ideal traveling data by comparing the acquired simulation traveling data with the ideal traveling data, and evaluates that the hyperparameter is the determined hyperparameter when the evaluation value is equal to or less than an evaluation threshold.

3. The teacher data generation apparatus according to claim 1,
wherein the processing circuitry is further configured to
perform data conversion on a data element included in the acquired simulation sensor data, and calculate a feature amount from the converted simulation sensor data.

4. A teacher data generation method, comprising:
acquiring simulation sensor data indicating a surrounding environment of a mobile object, the simulation sensor data being reproduced in a mobile object simulator that acquires a control amount of the mobile object using a hyperparameter, and acquiring simulation traveling data indicating a track on which the mobile object has traveled in the mobile object simulator;
calculating a feature amount from the acquired simulation sensor data;
evaluating whether or not the hyperparameter is a determined hyperparameter by comparing the acquired simulation traveling data with ideal traveling data;
resetting the hyperparameter when it is evaluated that the hyperparameter is not the determined hyperparameter, and repeatedly resetting the hyperparameter until it is evaluated that the hyperparameter is the determined hyperparameter;
repeatedly operating the mobile object simulator to acquire a control amount of the mobile object using the reset hyperparameter; and
generating teacher data in which the hyperparameter evaluated as the determined hyperparameter and the calculated feature amount are paired.
